(19) United States
(12) Patent Application Publication
(10) Pub. No.: US 2019/0269129 A1
(43) Pub. Date: Sep. 5, 2019

(54) COMPOSITION CONTAINING 1,2-DIBROMO-2,4-DICYANOBUTANE (DBDCB) AND ZINC PYRITHIONE (ZPT)

(71) Applicant: LANXESS Deutschland GmbH, Cologne (DE)

(72) Inventors: Peter WACHTLER, Krefeld (DE); Tanja GERHARZ, Solingen (DE)

(73) Assignee: LANXESS Deutschland GmbH, Cologne (DE)

(21) Appl. No.: 16/416,339

(22) Filed: May 20, 2019

Related U.S. Application Data
(62) Division of application No. 15/504,342, filed on Jun. 6, 2017.

(30) Foreign Application Priority Data
Aug. 22, 2014 (EP) 14181920.1

(51) Int. Cl. A01N 37/34; A01N 59/16; C09D 5/14; A01N 43/40; C09D 5/02

(52) U.S. Cl. CPC A01N 37/34; A01N 59/16; C09D 5/025; A01N 43/40; C09D 5/14

(57) ABSTRACT

A composition, characterized in that it comprises 1,2-dibromo-2,4-dicyanobutane (DBDCB) and zinc pyrithione (ZPT) as active components.

This application is a divisional of pending U.S. patent application Ser. No. 15/504,342 filed Jun. 6, 2017, with the same title, which claims the right of priority under 35 U.S.C. § 119 (a)-(d) and 35 U.S.C. § 365 of International Application No. PCT/EP2015/069170, filed Aug. 20, 2015, which is entitled to the right of priority of European Patent Application No. 14181920.1 filed Aug. 22, 2014, the contents of which are hereby incorporated by reference in their entirety.

The present application relates to a composition comprising 1,2-dibromo-2,4-dicyanobutane (DBDCB) and zinc pyrithione (ZPT), to processes for producing the composition according to the invention and to the use thereof for protection of industrial materials from attack and/or destruction by microorganisms and also to industrial materials comprising the composition according to the invention.

1,2-Dibromo-2,4-dicyanobutane (DBDCB, “Tektamer 38”) is an active biocide which has long been used in practice for producing antimicrobial formulations for controlling harmful bacteria, fungi or yeasts in industrial or cosmetic preparations. This active substance in principle exhibits a broad antimicrobial effect against microorganisms such as bacteria, fungi or yeasts and has the advantage of good compatibility in many products requiring protection. However efficacy is not always satisfactory in some usages on account of the relatively high lipophilicity of DBDCB, and consequently the usage concentrations required to achieve good preservation may be in an economically unfavorable range. There is accordingly a need to be able to utilize the broad antimicrobial activity of DBDCB when used in small amounts.

U.S. Pat. No. 4,830,657 describes mixtures of DBDCB and the biocide 1,2-benzisothiazolin-3-one (BIT). However, in the active biocide mixtures the amount of BIT is too high to meet regulatory limits for the maximum allowable undeclared amount of BIT (not more than 49 ppm BIT as per 2nd amending regulation of CLP regulation 1272/2008, no. 286/2011 of 10 Mar. 2011, Official Journal of the European Union, p. 33; CLP regulation 1272/2008, no. 1272/2008 of 16 Dec. 2008, Official Journal of the European Union, p. 688).

A further active biocide having broad antimicrobial activity against bacteria, molds, yeast and algae is zinc pyrithione (zinc bis[2-pyridinethiolate]-N,N-dioxide; zinc 2-pyridinethione-1-oxide; ZPT). In the case of ZPT too, its relatively high lipophilicity has the result in practice that the inherently good activity of zink pyrithione cannot always be realized to the desired extent. The requirements of a universally employable biocide product are thus not fulfilled in all usages by ZPT as the sole biocidal active substance.

WO 2012130822 A1 describes mixtures of ZPT and 1,2-benzisothiazolinones (BIT). However, here too the amount of BIT required for satisfactory biocidal activity is such that the maximum allowable undeclared amount of BIT is exceeded (for reasons analogous to the above).

There is therefore a need for improved product combinations in order to optimize the inherent antimicrobial activity spectrum of DBDCB/of ZPT.

Surprisingly, a composition based on 1,2-dibromo-2,4-dicyanobutane (DBDCB) and zinc pyrithione (ZPT) has now been found which overcomes the disadvantages of the respective individual components in advantageous fashion. Furthermore, the composition according to the invention surprisingly exhibits a synergistic effect.

The present invention thus relates to a composition which is characterized in that it comprises 1,2-dibromo-2,4-dicyanobutane (DBDCB) and zinc pyrithione (ZPT) as active components.

The relative ratios of DBDCB and ZPT in the composition according to the invention may be varied over a wide range. The weight ratio of DBDCB to ZPT in the composition is preferably 100:1 to 1:100, particularly preferably 50:1 to 1:50, very particularly preferably 10:1 to 1:10, yet more preferably 4:1 to 1:4.

Furthermore in the composition according to the invention preferably at least 60 wt %, particularly preferably at least 80 wt %, very particularly preferably at least 90 wt %, yet more preferably at least 95 wt %, of the sum of the active components DBDCB and ZPT are present in dissolved form.

The composition according to the invention is moreover surprisingly notable in that it exhibits an unexpectedly high, synergistic activity enhancement in specific mixture ratios. Consequently the usage concentrations required for protection of industrial products in the case of the composition according to the invention may be reduced compared to the required concentrations in the case of the respective individual active substances. This is highly advantageous from economic, environmental and performance perspectives and represents a contribution to increasing preservation quality.

Further Biocidal Active Substances

In addition to DBDCB and ZPT the composition according to the invention may additionally comprise no further biocidal active substance or at least one further biocidal active substance.

The composition according to the invention preferably comprises DBDCB, ZPT and additionally at least one further biocidal active substance.

Preferable further biocidal active substances include the following active substances:
benzalkonium chloride
1,2-benzisothiazol-3(2H)-one (BIT)
benzyl alcohol
2-bromo-2-nitropropane-1 3-diol (Bronopol)
bromochlorodimethylhydantoin
5-chloro-2-methyl-4-isothiazolin-3-one/2-methyl-4-isothiazolin-3-one (OMIT/MIT)
2,2-dibromo-3-nitrilopropionamide (DBNPA)
diazolidinyl urea
3,3-dimethylol-5,5-dimethylhydantoin (DMDMH)
dichlorobenzyl alcohol
didecyldimethylammonium chloride
dimethylolhydantoin
4,4-dimethyl-1,3-oxazolidine
ethylene glycol bishemiformal
imidazolidinyl urea
iodopropargyl butylcarbamate (IPBC)
2-n-octylisothiazolin-3-one (OIT)
phenoxyethanol
phenyl ethyl alcohol
o-phenylphenol (OPP)
poly(hexamethylenebiguanide) hydrochloride (PHMB)
tetramethylolacetylene diurea (TMAD)

It is particularly preferable when the composition according to the invention comprises at least one further biocidal active substance selected from the group consisting of 1,2-benzisothiazol-3(2H)-one (BIT), iodopropargyl butylcarbamate (IPBC) and 2-n-octylisothiazolin-3-one (OIT).

The weight ratio of the at least one further biocidal active substance to the sum of DBDCB and ZPT is preferably 1:2 to 1:100.

In the composition according to the invention the sum of the wt % ages of DBDCB, ZPT and the additional no further biocidal active substance or at least one further biocidal active substance may be varied over a wide range.

The sum of DBDCB, ZPT and the additional no further biocidal active substance or at least one further biocidal active substance is preferably 1 to 80 wt %, particularly preferably 5 to 40%, based on the total weight of the composition according to the invention.

Further Added Substances

The composition according to the invention may comprise no further added substance or at least one further added substance.

The composition according to the invention preferably comprises at least one further added substance.

The composition according to the invention particularly preferably comprises at least zinc oxide (ZnO) as a further added substance.

The weight ratio of ZnO to the sum of the components DBDCB, ZPT and optionally at least one further biocidal active substance may be varied over a wide range. The weight ratio of ZnO to the sum of the components DBDCB, ZPT and optionally at least one further biocidal active substance is preferably 1:1 to 1:10.

One advantage of the preferred composition according to the invention, which comprises ZnO, is protection from possible discoloration.

The application of the composition according to the invention may, depending on its respective physical and/or chemical properties/the specific requirements of the preservation problem to be solved, be effected either separately in the form of a metered addition of the individual active substances, wherein individual adjustment of the concentration ratio may be undertaken depending on the preservation problem at issue, or metered addition of the composition according to the invention may be effected as a formulation.

The composition according to the invention is preferably present in the form of a formulation.

The composition according to the invention is particularly preferably present in the form of a formulation which is a solution, a dispersion, an emulsion, a suspension, a powder, a foam, a paste, a granulate, aerosol or a microencapsulated form in polymeric substances.

The composition according to the invention may thus further comprise or not comprise at least one auxiliary suitable for producing a formulation as a further added substance.

The composition according to the invention preferably comprises at least one auxiliary as a further added substance.

Preferred auxiliaries of the present invention are surface-active substances, wetting agents, emulsifiers, dispersants, stabilizers, adhesives, thickeners, spreading agents, organic solvents, fragrances, colorants, dedustants, buffering substances, buffer systems, pH regulators, solid carriers and water.

A particularly preferred auxiliary of the present invention is water.

The composition according to the invention preferably comprises at least one auxiliary selected from the group consisting of surface-active substances, wetting agents, emulsifiers, dispersants, stabilizers, adhesives, thickeners, spreading agents, organic solvents, fragrances, colorants, antidusting agents, buffering substances, buffer systems, pH regulators, solid carriers and water, particularly preferably water.

In a preferred composition according to the invention in which a plurality of auxiliaries from the abovementioned group are selected, these auxiliaries are distinct from one another.

The preferred auxiliaries of the present invention are more particularly elucidated by way of example hereinbelow:
Surface-active substances, for example surfactants. Surfactants may for example be nonionic, cationic and amphoteric surfactants, preferably anionic surfactants. Suitable anionic surfactants are for example alkyl sulfates, alkyl ether sulfates, alkylarylsulfonates, alkyl succinates, alkyl sulfosuccinates, N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, for example sodium, potassium, magnesium, calcium, and ammonium and triethanolamine salts. The alkyl ether sulfates, alkyl ether phosphates and alkyl ether carboxylates may each have for example between 1 to 10 ethylene oxide or propylene oxide units, preferably 1 to 3 ethylene oxide units. Suitable are for example sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate.
Wetting agents, for example alkali metal, alkaline earth metal and ammonium salts of aromatic sulfonic acids, for example ligno-, phenol-, naphthalene- and dibutylnaphthalenesulfonic acid, and of fatty acids, alkyl- and alkylaryl sulfonates, alkyl and lauryl ethers and fatty alcohol sulfates and also salts of sulfated hexa-, hepta- and octadecanols or fatty alcohol glycol ethers, condensation products of sulfonated naphthalene and its derivatives with formaldehyde, condensation products of naphthalene and of naphthalenesulfonic acids with phenol and formaldehyde, polyoxyethylene octylphenol ether, ethoxylated isooctyl-, octyl- or nonylphenol, alkylphenol or tributylphenyl polyglycol ethers, alkylaryl polyether alcohols, isotridecyl alcohol, fatty alcohol ethylene oxide condensates, ethoxylated castor oil, polyoxyethylene alkyl ethers or polyoxypropylene, lauryl alcohol polyglycol ether acetate, sorbitol ester, lignosulfite waste liquors or methylcellulose.
Emulsifiers, for example sodium, potassium and ammonium salts of straight-chain aliphatic carboxylic acids of chain length C₁₂-C₂₀, sodium hydroxyoctadecanesulfonate, sodium, potassium and ammonium salts of hydroxy fatty acids of chain length C₁₂-C₂₀ and the sulfation or acetylation products thereof, alkyl sulfates, also as triethanolamine salts, alkyl-(C₁₀-C₂₀)-sulfonates, alkyl-(C₁₀-C₂₀)-arylsulfonates, dimethyldialkyl-(C₈-C₁₈)-ammonium chloride, acyl, alkyl, oleyl and alkylaryl oxethylates and the sulfation products thereof, alkali metal salts of sulfosuccinic acid esters with aliphatic saturated monohydric alcohols of chain length C₄-C₁₆, sulfosuccinic acid 4-ester with polyethylene glycol ethers of monohydric aliphatic alcohols of chain length C₁₀-C₁₂ (disodium salt), sulfosuccinic acid 4-ester with polyethylene glycol nonylphenyl ether (disodium salt), sulfosuccinic acid bis-cyclohexyl ester (sodium salt), lignosulfonic acid and the calcium, magnesium, sodium and ammonium salts thereof, polyoxyethylene sorbitan monooleate with 20 ethylene oxide groups, uric acids, hydrogenated and dehydrogenated uric acids, and alkali metal salts thereof, dodecylated diphenyl ether disulfonic acid sodium, and copolymers of ethylene oxide and propylene oxide with a minimum content of 10 wt % of ethylene oxide. Preferably used emulsifiers are: sodium lauryl sulfate, sodium lauryl ether sulfate, ethoxylated (3 ethylene oxide groups); the polyethylene glycol (4-20)ethers of oleyl alcohol, and the polyethene oxide (4-14)ethers of nonylphenol.
Dispersants for example alkylphenol polyglycol ethers.
Stabilizers, for example cellulose and cellulose derivatives.
Adhesives and thickeners, for example carboxymethylcellulose, natural and synthetic pulverulent, granular or latex-like polymers are employed, such as gum Arabic, polyvinyl alcohol, polyvinyl acetate and natural phospholipids, such as cephalins and lecithins and synthetic phospholipid and also mineral or vegetable oils.
Spreading agents, for example isopropyl myristate, polyoxyethylene nonylphenyl ether and polyoxyethylene laurylphenyl ether.
Organic solvents, for example mono- or polyhydric alcohols, esters, ketones and hydrocarbons. Examples of suitable solvents are paraffins, for example crude oil fractions, mineral and vegetable oils, butanol or glycol and the ethers and esters thereof, ketones such as acetone, methyl ethyl ketone, methyl isobutyl ketone or cyclohexanone.
Fragrances, colorants, such as inorganic pigments, for example iron oxide, titanium oxide, Prussian blue and organic colorants, such as alizarin, azo and metallophthalocyanine colorants and trace nutrients such as salts of iron, manganese, boron, copper, cobalt, molybdenum and zinc.
Dedusting agents, for example polyglycols and polyglycol ethers. The at least substantially solid formulations may respectively comprise for example 0.01 to 2, preferably 0.05 to 1, particularly preferably 0.1 to 0.5, wt % of dedusting agents.
Buffering substances, buffer systems or pH regulators. The at least substantially solid formulations may respectively comprise for example 0.01 to 10, preferably from 0.1 to 5, wt % of buffering substances, buffer systems or pH regulators.
Solid carriers, for example natural rock flours, such as kaolins, clays, talc, chalk, quartz, attapulgite, montmorillonite or diatomaceous earth, and synthetic rock flours, such as finely divided silica, aluminium oxide and silicates. Suitable solid carriers, in particular for granulates, include for example: crushed and fractionated natural rocks, such as calcite, marble, pumice, sepiolite and dolomite, and also synthetic granulates made of inorganic and organic flours and also granulates made of organic material such as sawdust, coconut shells, corn cobs and tobacco stalks.
Water

The composition according to the invention preferably comprises at least water as an auxiliary.

The composition according to the invention preferably comprises 20-99 wt %, particularly preferably 60 to 95 wt %, of at least one further added substance based on the total weight of the composition according to the invention.

Production

The invention further relates to a process for producing the composition according to the invention, characterized in that it comprises mixing together DBDCB and ZPT, optionally with addition of at least one further biocidal active substance and optionally with addition of at least one further added substance.

A preferred production of the composition according to the invention is characterized in that it comprises mixing together DBDCB and ZPT and at least one further added substance, preferably an auxiliary.

A further preferred production of the composition according to the invention is characterized in that it comprises mixing together DBDCB and ZPT, at least one further biocidal active substance and at least one auxiliary.

A particularly preferred production of the composition according to the invention is characterized in that it comprises mixing together DBDCB, ZPT, at least one further biocidal active substance selected from the group consisting of BIT, IPBC and OIT, and at least one auxiliary.

The above indications concerning the further biocidal active substances, the added substances and auxiliaries apply analogously for the production according to the invention.

Use

The invention further relates to the use of the composition according to the invention for protection of industrial materials from attack and/or destruction by microorganisms.

It is preferable when the industrial materials which are to be protected from attack and/or destruction by microorganisms by use of the composition according to the invention are water-containing functional liquids and water-containing industrial products.

Mention may be made, by way of example but not by way of limitation, of use in the following industrial materials:
aqueous-based coatings, paints and renders
chemical products for building and construction such as concrete additives, for example based on molasses, lignin sulfonates or polyacrylates, bitumen emulsions or sealing compounds
printing thickeners based on natural raw materials such as alginates, guar flours, gum Arabic, maize, wheat or rice starches.
auxiliaries for the leather, textile or photochemical industry
cooling lubricant concentrates and/or aqueous emulsions or dilutions thereof for metal processing based on mineral oil-containing, semisynthetic or synthetic concentrates
glues and adhesives based on known raw materials of animal, vegetable or synthetic origin
polymer dispersions based on for example polyacrylate, polystyrene acrylate, styrene-butadiene, polyvinyl acetate
starch solutions or slurries or other starch-based products, such as, for example, printing thickeners or wallpaper paste
slurries of other raw materials such as color pigments (for example iron oxide pigments, carbon black pigments, titanium dioxide pigments) or slurries of fillers and coating pigments, such as kaolin, calcium carbonate or talc
chemical industry precursors and intermediates, for example in colorant production and storage
solvent- or water-borne inks
wax and clay emulsions

The composition according to the invention is particularly preferably employed for protection of aqueous-based coatings, paints and renders, chemical products for building and construction, for example bitumen emulsions or sealing compounds, auxiliaries for the leather or textile industry, glues and adhesives based on known raw materials of animal, vegetable or synthetic origin, polymer dispersions based on for example polyacrylate, polystyrene acrylate, styrene-butadiene, polyvinyl acetate and/or chemical industry precursors and intermediates in colorant production and colorant storage.

The use concentrations of the inventive mixture to be used in accordance with the invention depend on the type and the incidence of the microorganisms to be controlled, on the initial microbial load, on the expected storage time of the products to be protected and on the composition of the microbiologically susceptible end products. The optimum usage amount may be determined in simple fashion in a manner sufficiently familiar to those skilled in the art by preliminary experiments and test series in the laboratory.

The composition according to the invention is preferably employed for protection of industrial materials in amounts in the range from 0.01 to 5 wt %, particularly preferably from 0.05 to 1.0 wt %, based on the weight of the material to be protected.

The invention further relates to industrial materials that have been treated with the composition according to the invention.

The present invention further relates to industrial materials comprising a composition according to the invention.

The above industrial materials recited by way of example apply analogously for the industrial materials.

The composition according to the invention is active against a very wide variety of microorganisms, for example bacteria, molds, yeasts and slime organisms.

Mention may be made, by way of example but not by way of limitation, of the following types against which the composition according to the invention shows activity:

Bacteria:

Alcaligenes such as Alcaligenes faecalis, Bacillus such as Bacillus subtilis, Enterobacter such as Enterobacter aerogenes, Escherichia such as Escherichia coli, Proteus such as Proteus vulgaris, Pseudomonas such as Pseudomonas aeruginosa or Pseudomonas fluorescens, Serratia such as Serratia marescens, Staphylococcus such as Staphylococcus aureus.

Yeasts:

Candida such as Candida albicans, Geotrichum such as Geotrichum candidum, Rhodotorula such as Rhodotorula rubra, Rhodotorula mucilaginosa, Saccharomyces such as Saccharomyces cerevisiae.

Fungi:

Acremonium such as Acremonium strictum, Alternaria such as Alternaria tenuis, Aspergillus such as Aspergillus niger, Chaetomium such as Chaetomium globosum, Fusarium such as Fusarium solani, Lentinus such as Lentinus tigrinus, Paecilomyces such as Paecilomyces variotti, Penicillium such as Penicillium glaucum, Trichoderma such as Trichoderma viride.

The examples which follow document by way of example but without limitation the surprising activity enhancement of the composition according to the invention:

### EXAMPLES

The synergism of the composition according to the invention is demonstrated hereinbelow by way of example against certain germs that are particularly relevant in practice, for example Pseudomonas aeruginosa (example 1).

The observed synergism of the composition according to the invention may be determined by the following mathematical formula (cf. F. C. Kull, P. C. Elisman, H. D. Sylwestrowicz, P. K. Mayer, Appl. Microbiol. 9, p. 538 (1961):

$$synergic index ( S I ) = \frac{{Q}_{a}}{{Q}_{A}} + \frac{{Q}_{b}}{{Q}_{B}}$$

where:
Qₐ=the amount of component A in the active substance mixture which achieves the desired effect, i.e. no microbial growth,
Q_{A}=the amount of component A which, when used on its own, suppresses the growth of the microorganisms,
Q_{b}=the amount of component B in the active substance mixture which suppresses the growth of the microorganisms,

and
Q_{B}=the amount of component B which, when used on its own, suppresses the growth of the microorganisms.

A synergistic index obtained according to the above formula of SI<1 indicates a synergistic effect for the active substance mixture. The smaller the SI, the greater the synergistic effect.

The synergistic activity enhancement is elucidated by way of example but not by way of limitation with reference to the examples and calculations which follow.

### Example 1: Synergism Toward Pseudomonas aeruginoasa

The minimum inhibitory concentration of the inventive compositions listed in table 1 were investigated using the test germ Pseudomonas aeruginoasa.

TABLE 1

| no. | DBDCB:ZPT | DBDCB [ppm], Qₐ | ZPT [ppm], Q_{b} | SI |
|---|---|---|---|---|
| 1 | 8:2 | 200 | 50 | 0.91 |
| 2 | 6:4 | 45 | 30 | 0.68 |
| 3 | 5:5 | 37.5 | 37.5 | 0.65 |
| 4 | 4:6 | 30 | 45 | 0.72 |
| 5 | 2:8 | 10 | 40 | 0.57 |
| 6 | 1:9 | 7.5 | 67.5 | 0.93 |

(test germ: Pseudomonas aeruginosa, Q_{A} = 250 ppm of DBDCB, Q_{B} = 75 ppm of zinc pyrithione)

In certain concentration ratios the inventive compositions show a distinct synergistic effect against the test germ Pseudomonas aeruginoasa.

### Example 2: Synergism Toward Enterobacter aerogenes

The minimum inhibitory concentration of the inventive compositions listed in table 2 were investigated using the test germ Enterobacter aerogenes.

TABLE 2

| no. | DBDCB:ZPT | DBDCB [ppm], Qₐ | ZPT [ppm], Q_{b} | SI |
|---|---|---|---|---|
| 1 | 9:1 | 78 | 9 | 0.96 |
| 2 | 6:4 | 30 | 20 | 0.90 |
| 3 | 5:5 | 25 | 25 | 0.75 |
| 4 | 4:6 | 20 | 30 | 0.80 |
| 5 | 2:8 | 10 | 40 | 0.82 |

(test germ: Enterobacter aerogenes, Q_{A} = 100 ppm of DBDCB, Q_{B} = 50 ppm of zinc pyrithione)

In certain concentration ratios the inventive compositions show a distinct synergistic effect against the test germ Enterobacter aerogenes.

### Example 3: Synergism Toward Rhodotorula mucilaginosa

The minimum inhibitory concentration of the inventive compositions listed in table 3 were investigated with the test germ Rhodotorula mucilaginosa.

TABLE 3

| no. | DBDCB:ZPT | DBDCB [ppm], Qₐ | ZPT [ppm], Q_{b} | SI |
|---|---|---|---|---|
| 1 | 9:1 | 22.5 | 2.5 | 0.55 |
| 2 | 8:2 | 20 | 5 | 0.60 |
| 3 | 6:4 | 15 | 10 | 0.70 |
| 4 | 5:5 | 12.5 | 12.5 | 0.75 |
| 5 | 4:6 | 10 | 15 | 0.80 |
| 6 | 2:8 | 5 | 20 | 0.90 |
| 7 | 1:9 | 2.5 | 22.5 | 0.95 |

(test germ: Rhodotorula mucilaginosa, Q_{A} = 50 ppm of DBDCB, Q_{B} = 25 ppm of zinc pyrithione)

In certain concentration ratios the inventive compositions show a distinct synergistic effect against the test germ (yeast) Rhodotorula mucilaginosa.

### Example 4: Microbiological Stress Test—Preservation of a Polymer Emulsion

The preserving effect of an inventive composition comprising DBDCB and ZPT in a polymer emulsion (acrylate-based, pH=6.5) was investigated using a microbiological stress test.

The microbiological stress test examines the susceptibility of water-based systems to microbial attack and the effect of preservatives. To this end, the preservatives are incorporated in defined concentrations into the water-based systems. After the preparations have been completed, contamination with microorganisms of a defined type is effected at weekly intervals over a test period of 3 to not more than 6 weeks. 2-3 days and 7 days after each contamination, germ number determination is used to establish whether a complete kill or at least propagation inhibition of the introduced microorganisms compared to the unpreserved control samples has been achieved.

Having knowledge of the microorganism populations prevalent in polymer emulsions and dispersions the experiment employed a mixture of the following microorganism types for testing:

Bacteria: Escherichia coli, Pseudomonas aeruginosa and Staphylococcus aureus.

Molds: Acremonium strictum, Aspergillus niger and Geotrichum candidu.

Yeasts: Candida albicans and Rhodotorula rubra.

Very good activity is achieved when the preserved samples achieve a complete kill (0 bacteria/mold/yeast cells per g) of the introduced microorganisms (score of 3=very good).

The effect is deemed good when compared to the unpreserved sample (so-called reference sample) a markedly reduced microbe level is observed (10³−10¹ bacteria/10²−10¹ mold/yeast cells per g) (score of 2=good).

The effect is deemed fair when compared to the unpreserved sample a mildly reduced microbe level is observed (10⁴−10³ bacteria/10³−10² mold/yeast cells per g) (score of 1=fair).

The effect is deemed poor when compared to the unpreserved sample no reduction or only a minor reduction of the microbe level is observed (residual level of at least 10⁵ bacteria/10⁴ mold/yeast cells per g) (score of 0=poor). The results achieved are shown in table 4:

TABLE 4
Activity of the biocides determined 1 week after germ addition in
each case

| Biocide added | | | | | week | week | week |
|---|---|---|---|---|---|---|---|
| [wt %] | M | week 1 | week 2 | week 3 | 4 | 5 | 6 |
| 0.025% DBDCB | B | 0 | 0 | 0 | 0 | 0 | 0 |
| | S | 0 | 0 | 0 | 0 | 0 | 0 |
| | H | 0 | 0 | 0 | 0 | 0 | 0 |
| 0.050% DBDCB | B | 0 | 0 | 0 | 0 | 0 | 0 |
| | S | 0 | 0 | 0 | 0 | 0 | 0 |
| | H | 0 | 0 | 0 | 0 | 0 | 0 |
| 0.05% ZPT | B | 0 | 0 | 0 | 0 | 0 | 0 |
| | S | 2 | 2 | 2 | 2 | 2 | 2 |
| | H | 2 | 2 | 2 | 2 | 2 | 2 |
| 0.01% DBDCB + | B | 2 | 2 | 2 | 2 | 2 | 2 |
| 0.01% ZPT | S | 2 | 2 | 2 | 2 | 2 | 2 |
| | H | 2 | 2 | 2 | 2 | 2 | 2 |

(M = microorganism, B = bacteria, S = molds, H = yeasts)

Addition of an inventive composition comprising DBDCB and ZPT achieves effective preservation despite a markedly reduced active substance amount compared to the respective individual active substances, i.e. good activity is observed against all microorganism types employed for testing.

What is claimed is:

1. A method for protecting water-containing functional liquids and water-containing industrial products from attack and/or destruction by bacteria and/or yeast, the method comprising the steps of:
incorporating a biocide composition comprising active biocide component into the water-containing functional liquids and water-containing industrial products, wherein the active biocide component comprises 2-dibromo-2,4-dicyanobutane (DBDCB) and zinc pyrithione (ZPT) in a ratio of 10:1 to 1:10.

2. The method according to claim 1, wherein the active biocide component consists essentially of the 1,2-dibromo-2,4-dicyanobutane (DBDCB) and the zinc pyrithione (ZPT).

3. The method according to claim 1, wherein the biocide composition further comprises at least one further biocidal active substance, wherein the at least one further biocidal active substance is selected from the group of 1,2-benzisothiazol-3(2H)-one (BIT), iodopropargyl butylcarbamate (IPBC) and 2-n-octylisothiazolin-3-one (OIT).

4. The method according to claim 3, wherein the sum of DBDCB, ZPT and the at least one further biocidal active substance is 1 to 80 wt %, based on the total weight of the biocidal composition.

5. The method according to claim 3, wherein the biocide composition further comprises zinc oxide (ZnO), in a weight ratio of ZnO to the sum of the components DBDCB, ZPT and the at least one further biocidal active substance of 1:1 to 1:10.

6. The method according to claim 5, wherein the biocide composition further comprises 20 to 99 wt % of at least one auxiliary selected from the group consisting of surface-active substances, wetting agents, emulsifiers, dispersants, stabilizers, adhesives, thickeners, spreading agents, organic solvents, fragrances, colorants, antidusting agents, buffering substances, buffer systems, pH regulators, solid carriers and water.

7. The method according to claim 5, wherein the biocide composition further comprises 60 to 95 wt % at least one auxiliary selected from the group consisting of surface-active substances, wetting agents, emulsifiers, dispersants, stabilizers, adhesives, thickeners, spreading agents, organic solvents, fragrances, colorants, antidusting agents, buffering substances, buffer systems, pH regulators, solid carriers and water.

8. The method according to claim 1, wherein at least 60 wt % of the sum of the active components DBDCB and ZPT are present in the composition in dissolved form.

9. The method according to claim 1, wherein the biocide composition contains no further biocidal active substance, and the sum of the DBDCB and the ZPT is 1 to 80 wt %, based on the total weight of the composition.

10. The method according to claim 1, wherein the biocide composition further comprises zinc oxide, in a weight ratio of ZnO to the sum of the components DBDCB and ZPT of 1:1 to 1:10.

11. The method according to claim 1, wherein the 1,2-dibromo-2,4-dicyanobutane (DBDCB) and zinc pyrithione (ZPT) are present in synergistically effective amounts.

12. The method according to claim 1, wherein the DBDCB and the ZPT are present in the biocide composition at a weight ratio of DBDCB to ZPT of 4:1 to 1:4, and at least 95 wt % of the DBDCB and the ZPT are present in the biocide composition in dissolved form;
wherein the biocide composition further comprises at least one of:
at least one further biocidal active substance selected from the group consisting of 1,2-benzisothiazol-3(2H)-one (BIT), iodopropargyl butylcarbamate (IPBC) and 2-n-octylisothiazolin-3-one (OIT), such that the sum of DBDCB, ZPT and the at least one further biocidal active substance is 5 to 40 wt %, based on the total weight of the composition; and
zinc oxide (ZnO), in a weight ratio of ZnO to the sum of the components DBDCB, ZPT and the at least one further biocidal active substance of 1:1 to 1:10; and
the biocide composition is biocidally active against: Alcaligenes, Bacillus, Enterobacter, Escherichia, Proteus, Pseudomonas, Serratia, and Staphylococcus bacteria; Candida, Geotrichum, Rhodotorula, and Saccharomyces yeasts; and Acremonium, Alternaria, Aspergillus, Chaetomium, Fusarium, Lentinus, Paecilomyces, Penicillium, and Trichoderma fungi.

12. The method according to claim 1, wherein the biocide composition is present in relation to the product in an amount of 0.01 to 5 wt %, based on the weight of the product.
